(19) United States
(12) Patent Application Publication
(10) Pub. No.: US 2014/0323625 A1
(43) Pub. Date: Oct. 30, 2014

(54) Flame Retardant Thermoplastic Resin Composition and Article Comprising the Same

(71) Applicant: Cheil Industries Inc., Gumi-si (KR)

(72) Inventors: Pil Ho KIM, Uiwang-si (KR); Ki Uk KIM, Uiwang-si (KR); Ji Yea KIM, Uiwang-si (KR); Seung Shik SHIN, Uiwang-si (KR); Dong Kil CHOI, Uiwang-si (KR); Dong Hoon HAN, Uiwang-si (KR)

(73) Assignee: Cheil Industries Inc., Gumi-si (KR)

(21) Appl. No.: 14/040,716

(22) Filed: Sep. 29, 2013

(30) Foreign Application Priority Data
Apr. 25, 2013 (KR) 10-2013-0046334

(51) Int. Cl. C08L 69/00

(52) U.S. Cl. CPC C08L 69/00
USPC 524/127

(57) ABSTRACT

The flame retardant thermoplastic resin composition includes about 100 parts by weight of a polycarbonate resin; about 5 parts by weight to about 30 parts by weight of a rubber modified aromatic vinyl-based copolymer resin; about 10 parts by weight to about 30 parts by weight of an aromatic phosphoric acid ester compound; and about 5 parts by weight to about 100 parts by weight of fillers including wollastonite and talc, wherein a weight ratio of wollastonite to talc ranges from about 1:about 0.1 to about 1:about 0.5. In the flame retardant thermoplastic resin composition, wollastonite and talc are present in a specific ratio, which can provide excellent properties in terms of stiffness such as flexural modulus and bending characteristics, and flame retardancy.

### CROSS-REFERENCE TO RELATED APPLICATION

This application claims priority under 35 USC Section 119 to and the benefit of Korean Patent Application No. 10-2013-0046334, filed Apr. 25, 2013, the entire disclosure of which is incorporated herein by reference.

### FIELD OF THE INVENTION

The present invention generally relates to a flame retardant thermoplastic resin composition and an article comprising the same.

### BACKGROUND OF THE INVENTION

Polycarbonate resin is an engineering plastic material that has excellent properties in terms of mechanical strength, thermal resistance, transparency, and the like. Polycarbonate resins are used in various fields including office automation devices, electric/electronic components, materials for buildings, and the like. In particular, polycarbonate resins used in exterior materials of electric/electronic components such as TVs, monitors, notebook computers and the like, should exhibit high fluidity to achieve slim and thin structures as well as flame retardancy and stiffness.

Generally, a rubber modified aromatic vinyl-based copolymer resin has good properties in terms of processibility, impact strength, and external appearance, and can be used in electric/electronic products together with the thermoplastic polycarbonate resin. Particularly, flame retardant resins are used to manufacture a device designed to emit heat.

To impart flame retardancy to such a resin composition, a halogen-based flame retardant and an antimony compound or phosphorus compound are used in the art. However, since halogen-based flame-retardants generate toxic gases that are harmful to human health upon combustion, a method for imparting flame retardancy without using a halogen-based compound has attracted attention.

A compound containing phosphorus or nitrogen can be added to a resin composition to impart flame retardancy. Among the phosphorus compounds, a phosphoric acid ester compound is generally used as a representative flame retardant. However, a resin composition prepared using the phosphoric acid ester compound as the flame retardant can suffer from a “juicing” phenomenon, by which the flame retardant moves to and is deposited on the surface of a molded article during molding, and can have significantly reduced thermal resistance. To solve these problems, fillers can be added to the resin composition. However, the use of the fillers can deteriorate stiffness, particularly, flexural modulus.

Therefore, there is a need for a thermoplastic resin composition which exhibits excellent properties in terms of stiffness, flame retardancy, and the like even when using a phosphorus compound and fillers.

### SUMMARY OF THE INVENTION

The present invention provides a flame retardant thermoplastic resin composition, which can improve flame retardancy without deteriorating stiffness such as flexural modulus, bending characteristics, and the like, and is free from a halogen-based flame retardant to secure eco-friendliness, and an article comprising the same.

The flame retardant thermoplastic resin composition may include about 100 parts by weight of a polycarbonate resin; about 5 parts by weight to about 30 parts by weight of a rubber modified aromatic vinyl-based copolymer resin; about 10 parts by weight to about 30 parts by weight of an aromatic phosphoric acid ester compound; and about 5 parts by weight to about 100 parts by weight of fillers including wollastonite and talc, wherein a weight ratio of wollastonite to talc ranges from about 1:about 0.1 to about 1:about 0.5. The flame retardant thermoplastic resin composition includes a specific ratio of wollastonite and talc to improve stiffness such as flexural modulus, bending characteristics, and the like.

In one embodiment, the rubber modified aromatic vinyl group graft copolymer resin may include about 10 wt % to about 100 wt % of a graft copolymer resin comprising about 5 wt % to about 65 wt % of a rubbery polymer, about 15 wt % to about 94 wt % of an aromatic vinyl-based monomer, and about 1 wt % to about 50 wt % of a monomer copolymerizable with the aromatic vinyl-based monomer; and, optionally, about 90 wt % or less of an aromatic vinyl-based copolymer resin comprising about 50 wt % to about 95 wt % of an aromatic vinyl-based monomer, and about 5 wt % to about 50 wt % of a monomer copolymerizable with the aromatic vinyl-based monomer.

In one embodiment, the rubber-modified aromatic vinyl-based copolymer resin may include acrylonitrile-butadiene-styrene copolymer resin (ABS resin), acrylonitrile-ethylene propylene rubber-styrene copolymer resin (AES resin), acrylonitrile-acryl rubber-styrene copolymer resin (AAS resin), or a combination thereof.

In one embodiment, the aromatic phosphoric acid ester compound may be represented by Formula 2:

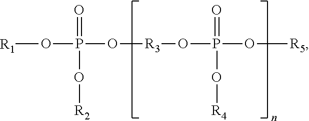

wherein R₁, R₂, R₄ and R₅ are the same or different and are each independently hydrogen, C₆ to C₂₀ aryl, or C₁ to C₁₀ alkyl-substituted C₆ to C₂₀ aryl; R₃ is C₆ to C₂₀ arylene or C₁ to C₁₀ alkyl-substituted C₆ to C₂₀ arylene; and n is an integer from 0 to 4.

In one embodiment, a weight ratio of the aromatic phosphoric acid ester compound to the fillers may range from about 1:about 0.2 to about 1:about 10.

In one embodiment, the flame retardant thermoplastic resin composition may further include at least one type of additive selected from among UV stabilizers, fluorescent brighteners, release agents, nucleating agents, inorganic additives, lubricants, antistatic agents, stabilizers, reinforcing agents, pigments, and/or dyes.

In one embodiment, the flame retardant thermoplastic resin composition may have a flame retardancy of V-0 or more as measured in accordance with UL-94 vertical testing, a flexural modulus from about 35,000 kgf/cm² to about 55,000 kgf/cm² as measured in accordance with ASTM D790, and a bending degree of about 0.01 mm to about 1 mm as measured on a specimen obtained by molding the flame retardant thermoplastic resin composition and having a size of about 6×6 in² and a thickness of about ⅛″ at about 25° C. and about 25% relative humidity (RH).

The present invention also relates to a molded article. The molded article comprises the flame retardant thermoplastic resin composition.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

In accordance with one embodiment, a flame retardant thermoplastic resin composition includes: (A) about 100 parts by weight of a polycarbonate resin; (B) about 5 parts by weight to about 30 parts by weight of a rubber modified aromatic vinyl-based copolymer resin; (C) about 10 parts by weight to about 30 parts by weight of an aromatic phosphoric acid ester compound; and (D) about 5 parts by weight to about 100 parts by weight of fillers including wollastonite and talc, wherein a weight ratio of wollastonite to talc ranges from about 1:about 0.1 to about 1:about 0.5.

(A) Polycarbonate Resin

According to the present invention, the polycarbonate resin is a thermoplastic polycarbonate resin, for example, an aromatic polycarbonate resin prepared by reacting one or more diphenols represented by Formula 1 with phosgene, halogen formate and/or carbonate diester.

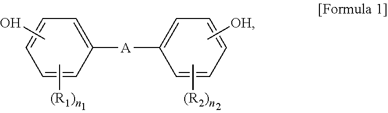

wherein A is a single bond, substituted or unsubstituted C₁ to C₅ alkylene, substituted or unsubstituted C₂ to C₅ alkylidene, substituted or unsubstituted C₃ to C₆ cycloalkylene, substituted or unsubstituted C₅ to C₆ cycloalkylidene, —CO—, —S—, or —SO₂—;

R₁ and R₂ are the same or different and are each independently substituted or unsubstituted C₁ to C₃₀ alkyl or substituted or unsubstituted C₆ to C₃₀ aryl; and

n1 and n2 are the same or different and are each independently an integer from 0 to 4.

As used herein, the term “substituted” means that a hydrogen atom of a compound is substituted by a substituent including halogen, C₁ to C₃₀ alkyl, C₁ to C₃₀ haloalkyl, C₆ to C₃₀ aryl, C₂ to C₃₀ heteroaryl, C₁ to C₂₀ alkoxy, or a combination thereof.

Examples of diphenols may include without limitation 4,4′-dihydroxydiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like, and combinations thereof. For example, 2,2-bis-(4-hydroxyphenyl)-propane, 2,2-bis-(3,5-dichloro-4-hydroxyphenyl)-propane, and/or 1,1-bis-(4-hydroxyphenyl)-cyclohexane may be used as the diphenol compound. In exemplary embodiments, 2,2-bis-(4-hydroxyphenyl)-propane (also referred to as “bisphenol-A”) may be used.

The polycarbonate resin may have a weight average molecular weight (Mw) from about 10,000 g/mol to about 200,000 g/mol, for example, from about 15,000 g/mol to about 80,000 g/mol, without being limited thereto.

The polycarbonate resin may be a branched polycarbonate resin, and may be prepared by, for example, adding, about 0.05 mol % to about 2 mol % of a tri or greater polyfunctional compound, for example, a compound having a tri- or greater valent phenol group, relative to the total amount of the diphenols used for polymerization.

The polycarbonate resin may be used in the form of a homopolycarbonate resin, a copolycarbonate resin or blends thereof.

In addition, the polycarbonate resin may be partially or completely replaced by an aromatic polyester-carbonate resin that is obtained by polymerization in the presence of an ester precursor, for example, bi-functional carboxylic acid.

(B) Rubber Modified Aromatic Vinyl-Based Copolymer Resin

In the invention, the rubber modified aromatic vinyl-based copolymer resin is a polymer wherein a rubbery polymer is dispersed in particle form in a matrix (continuous phase) of an aromatic vinyl-based polymer. For example, the rubber modified aromatic vinyl-based copolymer resin (B) may be prepared by adding an aromatic vinyl-based monomer and a monomer copolymerizable with the aromatic vinyl-based monomer to the rubbery polymer for polymerization.

The rubber modified aromatic vinyl-based copolymer resin may be prepared by emulsion polymerization, suspension polymerization, bulk polymerization, and the like. Typically, the rubber modified aromatic vinyl-based group copolymer resin may be prepared using a (B1) graft copolymer resin alone, or using both (B1) a graft copolymer resin and (B2) an aromatic vinyl-based copolymer resin (which does not include a rubbery polymer) through, for example, mixing and extrusion. Here, when mixing the (B 1) graft copolymer resin and the (B2) aromatic vinyl-based copolymer resin, it is desirable that these resins be mixed in consideration of compatibility. In addition, for bulk polymerization, the rubber modified aromatic vinyl-based copolymer resin may be prepared through single-stage process instead of separately preparing the graft copolymer resin and the aromatic vinyl-based copolymer resin. In either case, the final rubber modified aromatic vinyl-based copolymer resin can include the rubbery polymer in an amount of about 5 wt % to about 50 wt %, based on the total weight (100 wt %) of the final rubber modified aromatic vinyl-based copolymer resin. Further, the rubbery polymer can have a Z-average particle size of about 0.05 μm to about 6.0 μm. Within this range, the resin composition can exhibit excellent impact resistance.

(B1) Graft Copolymer Resin

In the present invention, the graft copolymer resin may be obtained through graft copolymerization of the aromatic vinyl-based monomer and the monomer copolymerizable with the aromatic vinyl-based monomer to the rubbery polymer, and may further include a monomer for imparting processibility and heat resistance, as needed.

Examples of the rubbery polymer may include without limitation diene rubbers such as polybutadiene, poly(styrene-butadiene), and poly(acrylonitrile-butadiene); acrylic rubbers such as saturated rubbers produced by adding hydrogen to diene rubbers, isoprene rubbers, and poly(butyl acrylate); ethylene/propylene/diene terpolymer (EPDM), and the like, and combinations thereof. In exemplary embodiments, diene rubbers, for example, butadiene rubber, may be used.

The graft copolymer resin may include the rubbery polymer in an amount of about 5 wt % to about 65 wt %, for example, about 10 wt % to about 60 wt %, and as another example about 20 wt % to about 50 wt %, based on the total amount (total weight, or 100 wt %) of the (B1) graft copolymer resin. In some embodiments, the graft copolymer resin may include the rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65 wt %. Further, according to some embodiments of the present invention, the amount of the rubbery polymer can be in a range from about any of the foregoing amounts to about any other of the foregoing amounts.

When the graft copolymer resin includes the rubbery polymer in an amount within this range, it is possible to obtain an excellent balance between impact resistance and mechanical properties.

The rubbery polymer (rubber particles) may have a Z-average particle size from about 0.05 μm to about 6 μm, for example from about 0.15 μm to about 4 μm, and as another example from about 0.25 μm to about 3.5 μm. Within this range, the resin composition can provide excellent impact strength and external appearance.

The aromatic vinyl-based monomer may be graft copolymerizable with the rubbery copolymer. Examples of the aromatic vinyl-based monomer may include without limitation styrene, α-methylstyrene, β-methylstyrene, p-methylstyrene, para-t-butylstyrene, ethylstyrene, vinylxylene, monochlorostyrene, dichlorostyrene, dibromostyrene, vinyl naphthalene, and the like, and combinations thereof. In exemplary embodiments, styrene may be used.

The graft copolymer resin may include the aromatic vinyl-based monomer in an amount of about 15 wt % to about 94 wt %, for example, about 20 wt % to about 80 wt %, and as another example about 30 wt % to about 60 wt %, based on the total amount (total weight or 100 wt %) of the (B1) graft copolymer resin. In some embodiments, the graft copolymer resin may include the aromatic vinyl-based monomer in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94 wt %. Further, according to some embodiments of the present invention, the amount of the aromatic vinyl-based monomer can be in a range from about any of the foregoing amounts to about any other of the foregoing amounts.

When the graft copolymer resin includes the aromatic vinyl-based monomer in an amount within this range, the resin composition can exhibit an excellent balance between impact resistance and mechanical properties.

Examples of the monomer copolymerizable with the aromatic vinyl-based monomer may include without limitation cyanated vinyl-based compounds such as acrylonitrile, unsaturated nitrile compounds such as ethacrylonitrile, methacrylonitrile and the like. These monomers may be used alone or in combination thereof.

The graft copolymer resin may include the monomer copolymerizable with the aromatic vinyl-based monomer in an amount of about 1 wt % to about 50 wt %, for example about 5 wt % to about 45 wt %, and as another example about 10 wt % to about 30 wt %, based on the total amount (total weight or 100 wt %) of the graft copolymer resin. In some embodiments, the graft copolymer resin may include the monomer copolymerizable with the aromatic vinyl-based monomer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the monomer copolymerizable with the aromatic vinyl-based monomer can be in a range from about any of the foregoing amounts to about any other of the foregoing amounts.

When the graft copolymer resin includes the monomer copolymerizable with the aromatic vinyl-based monomer in an amount within this range, the resin composition can exhibit an excellent balance between impact resistance and mechanical properties.

Examples of the monomer for imparting processibility and heat resistance may include without limitation acrylic acid, methacrylic acid, maleic acid anhydride, N-substituted maleimide, and the like, and combinations thereof.

The monomer for imparting processibility and heat resistance may optionally be present. For example, the graft copolymer resin may include the monomer for imparting processibility and heat resistance in an amount of about 15 wt % or less, for example, about 0.1 wt % to about 10 wt %, based on the total amount (total weight or 100 wt %) of the graft copolymer resin. In some embodiments, the graft copolymer resin may include the monomer for imparting processibility and heat resistance in an amount of 0 wt % (the monomer is not present), about 0 wt % (the monomer is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 wt %. Further, according to some embodiments of the present invention, the amount of the monomer for imparting processibility and heat resistance can be in a range from about any of the foregoing amounts to about any other of the foregoing amounts.

When the graft copolymer resin includes the monomer for imparting processibility and heat resistance in an amount within this range, the monomer can impart processibility and heat resistance to the resin composition without deteriorating other properties.

(B2) Aromatic Vinyl-Based Copolymer Resin

In the present invention, the aromatic vinyl-based copolymer resin (B2) may be prepared from a mixture of the monomers of the (B1) graft copolymer resin (B1), and in this case, the ratio of the monomers can be changed according to compatibility. For example, the aromatic vinyl-based copolymer resin may be obtained by copolymerization of the aromatic vinyl-based monomer and a monomer copolymerizable with the aromatic vinyl-based monomer.

Examples of the aromatic vinyl-based monomer may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinylnaphthalene, and the like, and combinations thereof. In exemplary embodiments, styrene may be used as the aromatic vinyl-based monomer.

Examples of the monomer copolymerizable with the aromatic vinyl-based monomer may include without limitation cyanated vinyl-based compounds such as acrylonitrile, unsaturated nitrile compounds such as ethacrylonitrile, methacrylonitrile and the like. These monomers may be used alone or in combination thereof.

The aromatic vinyl-based copolymer resin may further include a monomer for imparting processibility and heat resistance, as needed. Examples of the monomer for imparting processibility and heat resistance may include without limitation acrylic acid, methacrylic acid, maleic acid anhydride, N-substituted maleimide, and the like, and combinations thereof.

The aromatic vinyl-based copolymer resin may include the aromatic vinyl-based monomer in an amount of about 50 wt % to about 95 wt %, for example, about 60 wt % to about 90 wt %, and as another example about 70 wt % to about 80 wt %, based on the total amount (total weight or 100 wt %) of the aromatic vinyl-based copolymer resin. In some embodiments, the aromatic vinyl-based copolymer resin may include the aromatic vinyl-based monomer in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the aromatic vinyl-based monomer can be in a range from about any of the foregoing amounts to about any other of the foregoing amounts.

When the aromatic vinyl-based copolymer resin includes the aromatic vinyl-based monomer in an amount within this range, the resin composition can exhibit excellent balance between impact resistance and mechanical properties.

The aromatic vinyl-based copolymer resin may include the monomer copolymerizable with the aromatic vinyl-based monomer in an amount of about 5 wt % to about 50 wt %, for example, about 10 wt % to about 40 wt %, and as another example about 20 wt % to about 30 wt %%, based on the total amount (total weight or 100 wt %) of the aromatic vinyl-based copolymer resin. In some embodiments, the aromatic vinyl-based copolymer resin may include the monomer copolymerizable with the aromatic vinyl-based monomer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the monomer copolymerizable with the aromatic vinyl-based monomer can be in a range from about any of the foregoing amounts to about any other of the foregoing amounts.

When the aromatic vinyl-based copolymer resin includes the monomer copolymerizable with the aromatic vinyl-based monomer in an amount within this range, the resin composition can exhibit an excellent balance between impact resistance and mechanical properties.

In addition, the monomer for imparting processibility and heat resistance may optionally be present in the aromatic vinyl-based copolymer resin. For example, the aromatic vinyl-based copolymer resin may include the monomer for imparting processibility and heat resistance an amount of about 30 wt % or less, for example, about 0.1 wt % to about 20 wt %, based on the total amount (total weight or 100 wt %) of the aromatic vinyl-based copolymer resin. In some embodiments, the aromatic vinyl-based copolymer resin may include the monomer for imparting processibility and heat resistance in an amount of 0 wt % (the monomer is not present), about 0 wt % (the monomer is present), 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the monomer for imparting processibility and heat resistance can be in a range from about any of the foregoing amounts to about any other of the foregoing amounts.

When the aromatic vinyl-based copolymer resin includes the monomer for imparting processibility and heat resistance in an amount within this range, the monomer can impart processibility and heat resistance to the resin composition without deteriorating other properties.

The aromatic vinyl-based copolymer resin may have a weight average molecular weight of about 50,000 g/mol to about 500,000 g/mol, without being limited thereto.

Examples of the rubber modified aromatic vinyl-based copolymer resin may include without limitation acrylonitrile-butadiene-styrene copolymer (ABS) resins, acrylonitrile-ethylene propylene rubber-styrene copolymer (AES) resins, acrylonitrile-acryl rubber-styrene copolymer (AAS) resins, and the like, and combinations thereof. In exemplary embodiments, the rubber modified aromatic vinyl-based copolymer resin may include an ABS resin, such as a copolymer (g-ABS) obtained by grafting a styrene monomer, which is an aromatic vinyl compound, and an acrylonitrile monomer, which is an unsaturated nitrile compound, to a core butadiene rubbery polymer, which is dispersed as the graft copolymer (B1) in a styrene-acrylonitrile (SAN) copolymer resin as the aromatic vinyl copolymer (B2).

Further, in the rubber modified aromatic vinyl-based copolymer resin, the graft copolymer resin may be present in an amount of about 10 wt % to about 100 wt %, for example about 15 wt % to about 90 wt %, and the aromatic vinyl-based copolymer may be optionally present in an amount of about 90 wt % or less, for example about 10 wt % to about 85 wt %.

In some embodiments, the rubber modified aromatic vinyl-based copolymer resin (B) may include the graft copolymer resin (B1) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %. Further, according to some embodiments of the present invention, the amount of the graft copolymer resin (B1) can be in a range from about any of the foregoing amounts to about any other of the foregoing amounts.

In some embodiments, the rubber modified aromatic vinyl-based copolymer resin (B) may include the aromatic vinyl-based copolymer (B2) in an amount of 0 wt % (the aromatic vinyl-based copolymer (B2) is not present), about 0 wt % (the aromatic vinyl-based copolymer (B2) is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the aromatic vinyl-based copolymer (B2) can be in a range from about any of the foregoing amounts to about any other of the foregoing amounts.

When the rubber modified aromatic vinyl-based copolymer resin (B) includes the graft copolymer resin (B 1) and/or the aromatic vinyl-based copolymer (B2) in an amount within the above ranges, the resin composition can have an excellent balance between impact strength and mechanical properties.

The resin composition may include the rubber modified aromatic vinyl-based copolymer resin (B) in an amount of about 5 parts by weight to about 30 parts by weight, for example, about 10 parts by weight to about 25 parts by weight, and as another example about 15 parts by weight to about 20 parts by weight, based on about 100 parts by weight of the polycarbonate resin. In some embodiments, the resin composition may include the rubber modified aromatic vinyl-based copolymer resin (B) in an amount about 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the rubber modified aromatic vinyl-based copolymer resin (B) can be in a range from about any of the foregoing amounts to about any other of the foregoing amounts.

If the amount of the rubber modified aromatic vinyl-based copolymer resin is less than about 5 parts by weight relative to about 100 parts by weight of the polycarbonate resin, the impact resistance of the resin composition can deteriorate, and when the amount of the rubber modified aromatic vinyl-based copolymer is greater than about 30 parts by weight relative to about 100 parts by weight of the polycarbonate resin, flame retardancy of the resin composition can deteriorate.

(C) Aromatic Phosphoric Acid Ester Compound

In the present invention, the aromatic phosphoric acid ester compound may be any conventional aromatic phosphoric acid ester flame retardant used in a typical flame retardant thermoplastic resin composition, for example, an aromatic phosphoric acid ester compound represented by Formula 2:

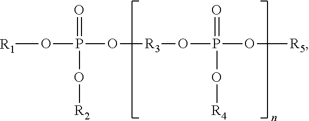

wherein R₁, R₂, R₄ and R₅ are the same or different and are each independently hydrogen, C₆ to C₂₀ aryl, or C₁ to C₁₀ alkyl-substituted C₆ to C₂₀ aryl;

R₃ is C₆ to C₂₀ arylene or C₁ to C₁₀ alkyl-substituted C₆ to C₂₀ arylene derived from dialcohols such as resorcinol, hydroquinol, bisphenol-A, bisphenol-S, and the like; and

n is an integer from 0 to 4.

Examples of the aromatic phosphoric acid ester compound represented by Formula 2 may include, in the case where n is 0, diarylphosphate, such as diphenylphosphate and the like, triphenylphosphate, tricresilphosphate, trixylenylphosphate, tri(2,6-dimethylphenyl)phosphate, tri(2,4,6-trimethylphenyl)phosphate, tri(2,4-ditertiarybutylphenyl)phosphate, tri(2,6-dimethylphenyl)phosphate, and the like, in the case where n is 1, resorcinol bis(diphenyl)phosphate, resorcinol bis(2,6-dimethylphenyl)phosphate, resorcinol bis(2,4-ditertiarybutylphenyl)phosphate, hydroquinol bis(2,6-dimethylphenyl)phosphate, hydroquinol bis(2,4-ditertiarybutylphenyl)phosphate, and the like. These aromatic phosphoric acid ester compounds may be used alone or as mixtures thereof.

The resin composition may include the aromatic phosphoric acid ester compound in an amount of about 10 parts by weight to about 30 parts by weight, for example, about 15 parts by weight to about 25 parts by weight, based on about 100 parts by weight of the polycarbonate resin. In some embodiments, the resin composition may include the aromatic phosphoric acid ester compound in an amount about 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of aromatic phosphoric acid ester compound can be in a range from about any of the foregoing amounts to about any other of the foregoing amounts.

If the amount of the aromatic phosphoric acid ester compound is less than about 10 parts by weight relative to about 100 parts by weight of the polycarbonate resin, the flame retardancy of the resin composition can deteriorate, and if the amount of the aromatic phosphoric acid ester compound exceeds about 30 parts by weight, the stiffness of the resin composition can suffer from deterioration in stiffness.

(D) Fillers

In the present invention, the fillers includes wollastonite and talc, and may improve heat resistance, flame retardancy, and the like, without deteriorating stiffness such as flexural modulus, and the like.

Wollastonite is a white calcium-based acicular mineral. In the present invention, wollastonite may have an average particle diameter of about 1 μm to about 60 μm, for example, about 3 μm to about 40 μm, and an average aspect ratio of about 6 or more, for example, about 7 to about 20. As used herein, the average aspect ratio of wollastonite refers to a ratio (a/b) of an average length (longer diameter) (a) to an average diameter (b) of wollastonite particles. Within this range, the fillers may improve heat resistance, flame retardancy, and the like without deteriorating stiffness such as flexural modulus.

Talc may be typical talc particles having a flake shape, an acicular shape, and the like, and combinations thereof.

The weight ratio of wollastonite to talc (wollastonite:talc) may be about 1:about 0.1 to about 1:about 0.5, for example, about 1:about 0.2 to about 1:about 0.4. If the weight ratio of wollastonite to talc (wollastonite:talc) is less than about 1:about 0.1, the resin composition can suffer from deterioration of bending characteristics, and if the weight ratio of wollastonite to talc (wollastonite:talc) exceeds about 1:about 0.5, the resin composition can suffer from deterioration of flexural modulus.

The resin composition may include fillers in an amount of about 5 parts by weight to about 100 parts by weight, for example, about 10 parts by weight to about 90 parts by weight, based on about 100 parts by weight of the polycarbonate resin. In some embodiments, the resin composition may include filler in an amount about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 parts by weight. Further, according to some embodiments of the present invention, the amount of the filler can be in a range from about any of the foregoing amounts to about any other of the foregoing amounts.

If the amount of the fillers is less than about 5 parts by weight relative to about 100 parts by weight of the polycarbonate resin, the resin composition can suffer from deteriorated stiffness such as deteriorated flexural modulus and the like, and if the amount of the fillers exceeds about 100 parts by weight relative to about 100 parts by weight of the polycarbonate resin, the resin composition can suffer from deteriorated impact resistance.

In one embodiment, the weight ratio (C:D) of the aromatic phosphoric acid ester compound (C) to the fillers (D) may be about 1:about 0.2 to about 1:about 10, for example, about 1:about 0.3 to about 1:about 8. Within this range, the thermoplastic resin composition can have improved flame retardancy with minimal or no deterioration of flexural modulus.

In addition to the above components, the flame retardant thermoplastic resin composition may further include one or more additives. Examples of additives include without limitation UV stabilizers, fluorescent brighteners, release agents, nucleating agents, inorganic additives, lubricants, antistatic agents, stabilizers, reinforcing agents, coloring agents such as pigments and/or dyes, and the like, and combinations thereof, as needed. As used with reference to the additional additives, the inorganic additives do not include fillers such as wollastonite, talc, and the like. The resin composition may include the additives in an amount of about 0.1 parts by weight to about 10 parts by weight based on about 100 parts by weight of the polycarbonate resin, without being limited thereto.

The UV stabilizers serve to suppress color change and deterioration of reflectivity of the resin composition due to UV irradiation, and may include, without limitation, benzotriazole, benzophenone, triazine, and the like, and combinations thereof.

The fluorescent brighteners serve to improve reflectivity of the polycarbonate resin, and may include, without limitation, stilbene-bisbenzoxazole derivatives such as 4-(benzoxazole-2-yl)-4′-(5-methylbenzoxazole-2-yl)-stilbene, 4,4′-bis(benzoxazole-2-yl)-stilbene, and the like, and combinations thereof.

Examples of the release agent may include without limitation fluorine-containing polymers, silicone oils, metal salts of stearic acid, metal salts of montanic acid, montanic acid ester waxes, polyethylene waxes, and the like, and combinations thereof. Examples of the nucleating agent may include without clay, and examples of the inorganic additives may include without limitation glass fibers, silica, clay, calcium carbonate, calcium sulfate, glass beads, and the like, and combinations thereof.

According to the invention, the flame retardant thermoplastic resin composition can exhibit excellent properties in term of stiffness such as flexural modulus and bending characteristics and flame retardancy. The flame retardant thermoplastic resin composition may have a flame retardancy level of V-0 or higher as measured on a specimen with a thickness of about 1.2 mm in accordance with UL-94 vertical testing, a flexural modulus of about 35,000 kgf/cm² to about 55,000 kgf/cm², for example about 40,000 kgf/cm² to about 50,000 kgf/cm², as measured in accordance with ASTM D790, and a bending degree of about 0.01 mm to about 1 mm, for example, about 0.02 mm to about 0.8 mm, as measured on an about 1/16″ thick specimen having a size of 6×6 inch² at about 25° C. and about 25% RH. As used herein, the bending degree can be obtained using an about ⅛″ thick specimen having a size of 6×6 inch², which is obtained by extrusion or injection molding of the flame retardant thermoplastic resin composition at 250° C., by measuring a height of one edge of the specimen separated from the ground, with the other three edges of the specimen secured to a planar plate at about 25° C. and about 25% RH.

The flame retardant thermoplastic resin composition may be prepared in the form of pellets by mixing the above components and other optionally additive(s), followed by melt extrusion in an extruder. Various molded articles may be produced using the prepared pellets through various molding methods, such as injection molding, extrusion, vacuum molding, cast molding, and the like.

The present invention also relates to a molded article formed of the thermoplastic resin composition. Since the molded article can exhibit excellent properties in terms of stiffness, flame retardancy, and the like, the molded article may be broadly applied to components of electric and electronic products, exterior materials, automobile parts, miscellaneous goods, structural materials, and the like.

Next, the present invention will be explained in more detail with reference to some examples. However, it should be understood that these examples are provided for illustration only and are not to be in any way construed as limiting the present invention.

### EXAMPLES

### Example 1

Details of components used in Examples and Comparative Examples are as follows:

(A) Polycarbonate Resin

Bisphenol-A type polycarbonate having a weight average molecular weight (Mw) of 25,000 g/mol is used.

(B) Rubber Modified Aromatic Vinyl-Based Copolymer Resin

A resin prepared by kneading (B-1) 40 wt % of a styrene-based graft copolymer resin and (B-2) 60 wt % of a styrene-containing copolymer resin is used.

(B-1) Styrene-Based Graft Copolymer Resin (ABS Graft Copolymer Resin)

With 50 parts by weight of butadiene rubber latex placed in a reactor, 36 parts by weight of styrene, 14 parts by weight of acrylonitrile and 150 parts by weight of deionized water in terms of solid content are added to the reactor. Then, relative to the total solid content, 1.0 part by weight of potassium oleate, 0.4 parts by weight of cumene hydroperoxide, 0.2 parts by weight of a mercaptan-based chain transfer agent, 0.4 parts by weight of glucose, 0.01 parts by weight of iron sulfate hydrate, and 0.3 parts by weight of pyrophosphate sodium salt are added to the reactor and reacted at 75° C. for 5 hours, thereby preparing graft copolymer resin latex. 0.4 parts by weight of sulfuric acid is added to the resin latex to solidify the resin latex, thereby preparing styrene-based graft copolymer resin powder.

(B-2) Styrene-Containing Copolymer Resin (SAN Copolymer Resin)

In a reactor, 72 parts by weight of styrene, 28 parts by weight of acrylonitrile, 120 parts by weight of deionized water, 0.2 parts by weight of azobisisobutyronitrile, 0.4 parts by weight of tri-calcium phosphate, and 0.2 parts by weight of mercaptan-based chain transfer agent are placed and heated from room temperature to 80° C. for 90 minutes. Then, the reactor is maintained at this temperature for 240 minutes, thereby preparing a styrene-acrylonitrile copolymer resin (SAN) containing 25 wt % of acrylonitrile. The resin is washed with water, dehydrated, and dried, thereby preparing a styrene-containing copolymer resin powder. The styrene-containing copolymer resin has a weight average molecular weight of 180,000 g/mol to 200,000 g/mol.

(C) Aromatic Phosphoric Acid Ester Compound: Diarylphosphate (PX-200, DAIHACHI) is Used.

(D) Fillers

(D-1) Wollastonite (Nyglos 12, NYCO Minerals) Having an Aspect Ratio (a/b) of 10 and (D-2) Flake Talc (UPN HS-T 0.5, HAYASHI) are Used.

### Examples 1 to 3 and Comparative Examples 1 to 9

The respective components are introduced in amounts as listed in Table 1 into a twin-screw melt-extruder at 240° C. to 280° C., followed by melting and kneading, thereby preparing a resin composition in a chip state. The prepared chips are dried at 80° C. for 5 hours or more, followed by preparing specimens for measurement of flame retardancy and mechanical properties using a screw-type injector at 240° C. to 280° C. The prepared specimens are evaluated as to the following properties, and results are shown in Table 1.

Measurement of Properties

(1) Flame retardancy: 1.5 mm thick and 1.2 mm thick specimens are prepared to evaluate flame retardancy in accordance with a UL-94 vertical testing method.

(2) Vicat softening temperature (VST): VST is measured under a load of 5 kgf in accordance with ASTM D1525 (unit: ° C.).

(3) Izod impact strength: A notch is formed on a 3.2 mm thick Izod specimen to measure impact strength in accordance with ASTM D256 (unit: kgf·cm/cm).

(4) Flexural modulus: A 6.4 mm thick specimen is prepared for measurement of flexible modulus in accordance with ASTM D790 (unit: kgf/cm²).

(5) Bending degree: An about ⅛″ thick specimen having a size of 6×6 inch is prepared by extrusion or injection molding of the flame retardant thermoplastic resin composition at 250° C. Then, with three edges of the specimen secured to a planar plate at about 25° C. and about 25% RH, the height of one edge of the specimen separated from the ground is measured (unit: mm).

TABLE 1

| | Example | | | Comparative Example | | | | | | | |
|---|---|---|---|---|---|---|---|---|---|---|---|
| | 1 | 2 | 3 | 1 | 2 | 3 | 4 | 5 | 6 | 7 | 8 |
| (A) | 100 | 100 | 100 | 100 | 100 | 100 | 100 | 100 | 100 | 100 | 100 |
| (B) | 15 | 15 | 20 | — | 50 | 15 | 15 | 15 | 15 | 15 | 15 |
| (C) | 20 | 20 | 20 | 20 | 20 | 5 | 50 | 20 | 20 | 20 | 20 |
| (D-1) | 20 | 45 | 45 | 45 | 45 | 45 | 45 | — | 120 | — | 10 |
| (D-2) | 5 | 10 | 10 | 10 | 10 | 10 | 10 | — | — | 25 | 30 |
| Flame | V-0 | V-0 | V-0 | V-0 | Fail | Fail | V-0 | V-0 | V-0 | V-0 | V-0 |
| retardancy | | | | | | | | | | | |
| (1.5 mm) | | | | | | | | | | | |
| Flame | V-0 | V-0 | V-0 | V-0 | Fail | Fail | V-0 | Fail | V-0 | V-0 | V-0 |
| retardancy | | | | | | | | | | | |
| (1.2 mm) | | | | | | | | | | | |
| VST | 97 | 98 | 97 | 107 | 86 | 110 | 81 | 100 | 105 | 92 | 90 |
| Impact strength | 15 | 12 | 13 | 3 | 19 | 18 | 4 | 9 | 2 | 8 | 4 |
| Flexural | 42,000 | 44,000 | 41,000 | 48,500 | 33,000 | 32,000 | 40,000 | 29,000 | 55,000 | 34,000 | 34,000 |
| modulus | | | | | | | | | | | |
| Bending degree | 0.2 | 0.5 | 0.5 | 1.4 | 1.1 | 1.2 | 1.3 | 0.2 | 1.5 | 0.5 | 0.6 |

Unit: parts by weight

From the results in Table 1, it can be seen that the flame retardant thermoplastic resin compositions of Examples 1 to 3 exhibit excellent properties in terms of stiffness such as flexural modulus and bending characteristics, impact resistance, heat resistance, and flame retardancy.

On the other hand, in Comparative Example 1 wherein the (B) rubber-modified styrene copolymer is not used, Comparative Example 4 wherein an excess of the (C) aromatic phosphoric acid ester compound is used, and Comparative Example 6 wherein an excess of (D-1) wollastonite is used alone as the (D) fillers, the thermoplastic resin compositions suffer deterioration in impact resistance. Further, in Comparative Example 2 wherein an excess of the (B) rubber-modified styrene copolymer is used and in Comparative Example 3 wherein a small amount of the (C) aromatic phosphoric acid ester compound is used, the thermoplastic resin compositions suffer deterioration in flame retardancy. Further, in Comparative Example 5 wherein the (D) fillers are not used, the thermoplastic resin compositions suffer deterioration in flame retardancy and stiffness, and in Comparative Example 7 wherein (D-2) talc is used alone as the (D) fillers, the thermoplastic resin compositions suffer deterioration in heat resistance and flexural modulus. Further, in Comparative Example 8 wherein an excess of (D-2) talc is used relative to (D-1) wollastonite as the (D) fillers, the thermoplastic resin compositions suffer deterioration in flexural modulus.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A flame retardant thermoplastic resin composition comprising:
about 100 parts by weight of a polycarbonate resin;
about 5 parts by weight to about 30 parts by weight of a rubber modified aromatic vinyl-based copolymer resin;
about 10 parts by weight to about 30 parts by weight of an aromatic phosphoric acid ester compound; and
about 5 parts by weight to about 100 parts by weight of fillers comprising wollastonite and talc,
wherein a weight ratio of wollastonite to talc ranges from about 1:about 0.1 to about 1:about 0.5.

2. The flame retardant thermoplastic resin composition according to claim 1, wherein the rubber modified aromatic vinyl group graft copolymer resin comprises:
about 10 wt % to about 100 wt % of a graft copolymer resin, the graft copolymer resin comprising about 5 wt % to about 65 wt % of a rubbery polymer, about 15 wt % to about 94 wt % of an aromatic vinyl-based monomer, and about 1 wt % to about 50 wt % of a monomer copolymerizable with the aromatic vinyl-based monomer; and
optionally, about 90 wt % or less of an aromatic vinyl-based copolymer resin, the aromatic vinyl-based copolymer resin comprising about 50 wt % to about 95 wt % of an aromatic vinyl-based monomer, and about 5 wt % to about 50 wt % of a monomer copolymerizable with the aromatic vinyl-based monomer.

3. The flame retardant thermoplastic resin composition according to claim 1, wherein the rubber-modified aromatic vinyl-based copolymer resin comprises acrylonitrile-butadiene-styrene copolymer resin (ABS resin), acrylonitrile-ethylene propylene rubber-styrene copolymer resin (AES resin), acrylonitrile-acryl rubber-styrene copolymer resin (AAS resin), or a combination thereof.

4. The flame retardant thermoplastic resin composition according to claim 1, wherein the aromatic phosphoric acid ester compound is represented by Formula 2: 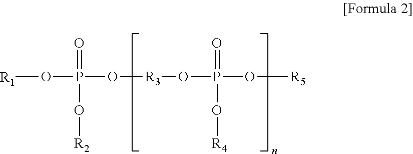
wherein R₁, R₂, R₄ and R₅ are the same or different and are each independently hydrogen, C₆ to C₂₀ aryl, or C₁ to C₁₀ alkyl-substituted C₆ to C₂₀ aryl; R₃ is C₆ to C₂₀ arylene or C₁ to C₁₀ alkyl-substituted C₆ to C₂₀ arylene; and n is an integer from 0 to 4.

5. The flame retardant thermoplastic resin composition according to claim 1, wherein a weight ratio of the aromatic phosphoric acid ester compound to the fillers ranges from about 1:about 0.2 to about 1:about 10.

6. The flame retardant thermoplastic resin composition according to claim 1, further comprising an additive selected from the group consisting of UV stabilizers, fluorescent brighteners, release agents, nucleating agents, inorganic additives, lubricants, antistatic agents, stabilizers, reinforcing agents, pigments, dyes, and combinations thereof.

7. The flame retardant thermoplastic resin composition according to claim 1, wherein the flame retardant thermoplastic resin composition has a flame retardancy of V-0 or more as measured in accordance with UL-94 vertical testing, a flexural modulus from about 35,000 kgf/cm² to about 55,000 kgfcm² as measured in accordance with ASTM D790, and a bending degree of about 0.01 mm to about 1 mm as measured on a specimen obtained by molding the flame retardant thermoplastic resin composition and having a size of about 6×6 in² and a thickness of about ⅛″ at about 25° C. and about 25% RH.

8. A molded article comprising the flame retardant thermoplastic resin composition according to claim 1.
